(19) United States
(12) Patent Application Publication
(10) Pub. No.: US 2016/0311251 A1
(43) Pub. Date: Oct. 27, 2016

(54) Customizable Wheel Cap

(71) Applicant: Frank Hodges, Corona, CA (US)

(72) Inventor: Frank Hodges, Corona, CA (US)

(21) Appl. No.: 14/697,610

(22) Filed: Apr. 27, 2015

(51) Int. Cl. B60B 7/04; B60B 7/08; B60B 7/14

(52) U.S. Cl. CPC B60B 7/04; B60B 7/14; B60B 7/08

(57) ABSTRACT

The invention comprises a customizable wheel cap with a metallic insert that can be etched or decorated wherein the insert fits on the outside surface of a wheel cap and a transparent protective cover.

### CROSS-REFERENCE TO RELATED APPLICATION

This application claims priority to U.S. provisional application No. 62/112,063 filed Feb. 4, 2015 the contents of which are hereby incorporated by reference.

### BACKGROUND OF THE INVENTION

Custom vehicles continue to evolve and offer more amenities for the occupants comfort. For example custom vehicles have incorporated large seats to simulate home bound recliners with foot rests. However, the ease of use for converting a jump seat into a luxury recliner has required numerous spring devices or other manual steps to fully implement. There is a need to automate the conversion process from a jump seat configuration and allow the operator to do so with the flip of a remote switch.

Other efforts to improve comfort in standard and custom vehicles have led to various methods of folding and actuating vehicle seats. Such methods and seats are intended to increase the useable space in vehicles for various purposes. U.S. Pat. No. 4,469,780 describes such a method for converting vehicle seats to a flat surface. Additional efforts to improve space utilization are disclosed in U.S. Pat. Nos. 4,779,926, and 6,591,554, and U.S. Pat. Publication Nos. 2004/0164582 and 2006/0273645.

Numerous efforts have been made to decorate wheel appearance by various methods. Such methods are generally expensive to implement and are not totally customizable. For example, the Wilson US Pat. Pub. 20030068212, the Somers U.S. Pat. No. 6,036,420, the Chavier U.S. Pat. No. 4,018,133, the Bydalek U.S. Pat. No. 5,772,377, and the Toth U.S. Pat. No. 4,955,773 disclose lug nuts that have decorative elements. Additionally, the Jenkins U.S. Pat. No. 6,637,829 and the Woodall European Pat. Pub. EP2572898 disclose decorative wheel caps. However, in Woodall the wheel caps are designed for wheel chair use and in Jenkins the decorations are designed to cover spoke elements, not a center cap on a wheel.

The above referenced patents and patent applications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

Although various decorative wheels and methods are known to the art, all, or almost all of them suffer from one or more than one disadvantage. Therefore, there is a need to provide a customizable wheel cap that can easily be adapted to any vehicle wheel cap.

### SUMMARY OF THE INVENTION

The present invention relates in general to decorative wheels. The current invention makes it possible for a vehicle owner to customize the face of a wheel cap. The wheel cap can easily be installed by a user by removing OEM manufactured center cap and replacing it with the customizable wheel cap. The customizable wheel cap has an insert generally in the shape of a circular disc wherein the outer face can be decorated. The insert is protected with a transparent covering.

### BRIEF DESCRIPTION OF THE FIGURES

In the following, embodiments of the present invention will be explained in detail on the basis of the drawings, in which:

FIG. 1 is an exploded view of a customizable wheel cap.

FIG. 2 is a perspective view of a customizable wheel cap with transparent cover partially removed.

### DETAILED DESCRIPTION

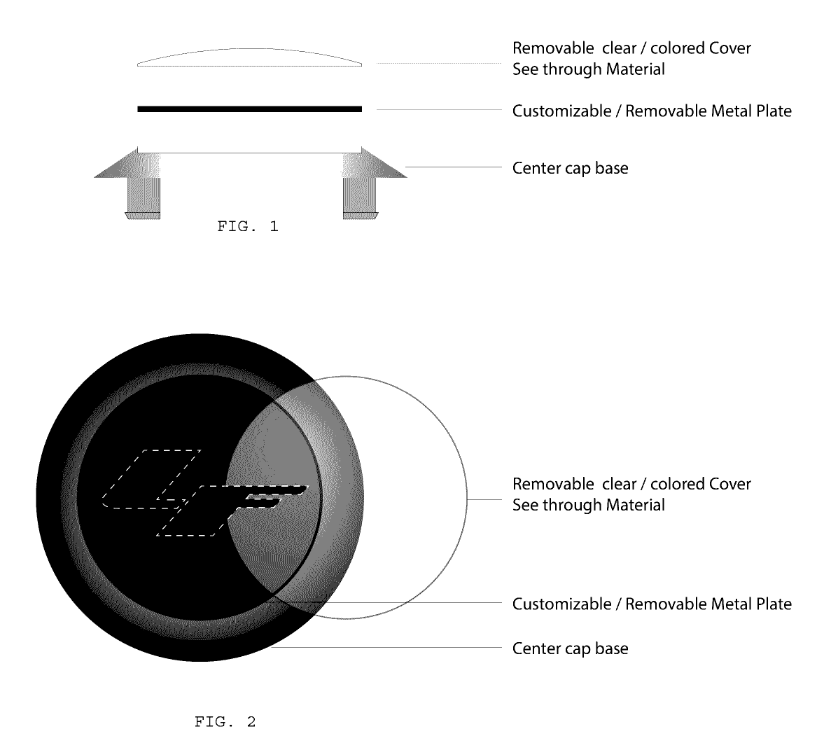

FIG. 1 shows a preferred embodiment of a customizable wheel cap wherein a base portion is configured to engage a wheel and remain fixed. An insert is adapted fit on an outer surface of the base portion. A transparent cover is further adapted fit over the insert and attach to the base portion. The method of attachment in a preferred embodiment is frictional fit with the base portion; however, other methods could be used, for example, an adhesive or screws are common methods. Additionally, the base portion could have rifled grooves adapted to receive the transparent cover by rotation. Alternatively, the base portion could have a groove capable of receiving the transparent cover by snap fit. The base portion may be made of metal or polymer materials. The insert can be made of aluminum, metal, glass, crystal, or polymer materials. The insert can be decorated with color, lettering, art by painting, dipping, etching or other common decorating means. The insert is not limited in shape, any shape could be adapted to the base portion, the only limitation being the dimensions on the wheel for receiving the base portion. Further the thickness of the insert can be between 0.1-20 millimeter with a preferred range of 2-10 millimeter. The transparent cover be made of glass, crystal, or polymeric materials. While the transparent cover is intended to provide protection to the insert it is not necessary that the cover be entirely transparent. For example, the cover could be colored or have occlusive elements that are decorative themselves or work in concert with the insert to provide a three dimensional effect.

FIG. 2 shows a preferred embodiment with a decorated circular insert and a transparent cover partially removed.

While the foregoing description sets forth various examples and details relating to preferred embodiments, it should be appreciated that the description is illustrative only and should not to be construed as limiting the invention. Thus, the scope of this disclosure is not to be limited by the illustrations or the foregoing descriptions thereof, but rather solely by the appended claims.

What is claimed is:

1. A customizable wheel cap comprising a base portion, an insert, and a transparent cover.

2. The customizable wheel cap of claim 1, where in the insert is made of one of the following: aluminum, metal, glass, crystal, and polymer materials.

3. The customizable wheel cap of claim 1, where in the base portion is made of one of the following: aluminum, metal, glass, crystal, and polymer materials.

4. The customizable wheel cap of claim 1, where in the transparent cover is made of one of the following: aluminum, metal, glass, crystal, and polymer materials.

5. The customizable wheel cap of claim 1, where in the transparent cover is attached to the base portion via frictional fit, snap fit, rifeled grooves, adhesive or screws.

6. The customizable wheel cap of claim 1, where in the insert is decorated with color, lettering, art by painting, dipping, and etching.
